(19) United States
(12) Patent Application Publication
(10) Pub. No.: US 2019/0302989 A1
(43) Pub. Date: Oct. 3, 2019

(54) DISPLAY CONTROL METHOD AND ELECTRONIC DEVICE THEREOF

(71) Applicant: Lenovo (Beijing) Co., Ltd., Beijing (CN)

(72) Inventors: Liang ZHANG, Beijing (CN); Hua LIN, Beijing (CN); Pengyueh HSUEH, Beijing (CN); Difan CHEN, Beijing (CN)

(21) Appl. No.: 16/370,334

(22) Filed: Mar. 29, 2019

(30) Foreign Application Priority Data
Mar. 30, 2018 (CN) 201810296469.2

(51) Int. Cl. G06F 3/0484; G06F 3/0488; G06F 3/01; G06F 9/451

(52) U.S. Cl. CPC G06F 3/04845; G06F 9/451; G06F 3/017; G06F 3/04886

(57) ABSTRACT

A display control method includes acquiring an instruction and displaying at least one of an application or a control on an entire display area of a display or a partial display area of the display based on the instruction. The entire display area of the display includes a non-regular display area.

### CROSS-REFERENCES TO RELATED APPLICATION

This application claims priority to Chinese Patent Application No. 201810296469.2, entitled “Display Control Method and Electronic Device Thereof” filed on Mar. 30, 2018, the entire content of which is incorporated herein by reference.

### FIELD OF TECHNOLOGY

The present disclosure relates to the field of image display for smart devices. More specifically, the present disclosure relates to a display control method and an electronic device thereof.

### BACKGROUND

In recent years, the production of electronic devices such as mobile phones has been on a trend to increase the screen ratio of electronic devices. At the same time, in order to arrange front camera, back camera, speakers, proximity sensors, etc., many manufacturers have started designing the display of the electronic devices in non-regular shapes, such as by cutting a portion off of the display at the top of the mobile phone to place the components mentioned above, so the shape of the display is no longer a rectangle. However, many applications and/or controls of the electronic devices are developed based on a rectangular display to properly display contents, therefore, the non-rectangular display may cause portions of the application and/or control to be undisplayable. In some cases, some applications and/or controls may be inoperable if a button or a menu is located in the cut off area of the display. However, if a rectangular area is randomly selected on the display as the display area of the applications and/or controls, some applications and/or controls (such as video, camera, etc.) cannot fully utilize the entire screen, hence lowering the user experience.

### BRIEF SUMMARY OF THE DISCLOSURE

One aspect of the present disclosure provides a display control method. The method includes acquiring an instruction and displaying at least one of an application or a control on an entire display area of a display or in a partial display area of the display based on the instruction. The entire display area of the display includes a non-regular display area.

Another aspect of the present disclosure provides an electronic device having a storage device, a display, and a processor. The storage device stores at least one of an application or a control, and a computer program. The display is configured to display the at least one of the application or the control. The processor is configured to execute the computer program to acquire an instruction and display the at least one of the application or control on the entire display area of the display or in a partial display area of the display based on the instruction. The entire display area of the display includes a non-regular display area.

### BRIEF DESCRIPTION OF THE DRAWINGS

For a more complete understanding of the present disclosure, and the advantages thereof, reference is now made to the following descriptions to be taken in conjunction with the accompanying drawings. The accompanying drawings in the following description show merely some embodiments of the present disclosure, and a person of ordinary skill in the art may still derive other drawings from these accompanying drawings without creative efforts.

FIG. 1 is a flowchart illustrating a display control method according to an embodiment of the present disclosure;

FIG. 2 is a flowchart illustrating process S1 of FIG. 1 according to an embodiment of the present disclosure; and

FIG. 3 is a schematic of a mobile phone according to an embodiment of the present disclosure.

### DETAILED DESCRIPTION

Hereinafter, aspects, features, and embodiments of the present disclosure will be described with reference to the accompanying drawings. It should be understood that such description is illustrative only but is not intended to limit the scope of the present disclosure.

In addition, it will be understood by those skilled in the art that various modifications in form and details may be made without departing from the spirit and scope of the present disclosure.

Features and aspects of the present disclosure will become apparent with reference to the accompanying drawings and non-limiting examples describing various embodiments of the present disclosure.

It will also be appreciated that although the present disclosure has been described with reference to some specific examples, equivalents of the present disclosure can be achieved by those skilled in the art. These equivalents having features claimed in the present disclosure should fall within the scope of protection defined hereinafter.

Hereinafter, embodiments of the present disclosure will be described with reference to the accompanying drawings. It should be understood that such description is illustrative only but is not intended to limit the scope of the present disclosure. In addition, in the following description, descriptions of well-known structures and techniques are omitted to avoid unnecessarily obscuring the concepts of the present disclosure. Therefore, specific structural and functional details disclosed herein are not intended to be limiting, but are merely used as a basis of the claims to teach those skilled in the art to use the present disclosure in various combinations.

The terms used herein are for the purpose of describing particular embodiments only but are not intended to limit the present disclosure. The words “a,” “an,” and “the” as used herein should also cover the meanings of “a plurality of” and “a variety of,” unless the context clearly dictates otherwise. In addition, the terms “comprising,” “including,” “containing,” and the like as used herein indicate the presence of the features, steps, operations and/or components, but do not preclude the presence or addition of one or more other features, steps, operations, or components.

The phrases “in an embodiment,” “in another embodiment,” or “in other embodiments” may refer to the same or different embodiments accordingly to the present disclosure.

The accompanying drawings illustrating embodiments of the present disclosure along with the summary of disclosure provided above and the detailed description provided below serve to explain the concepts of the present disclosure.

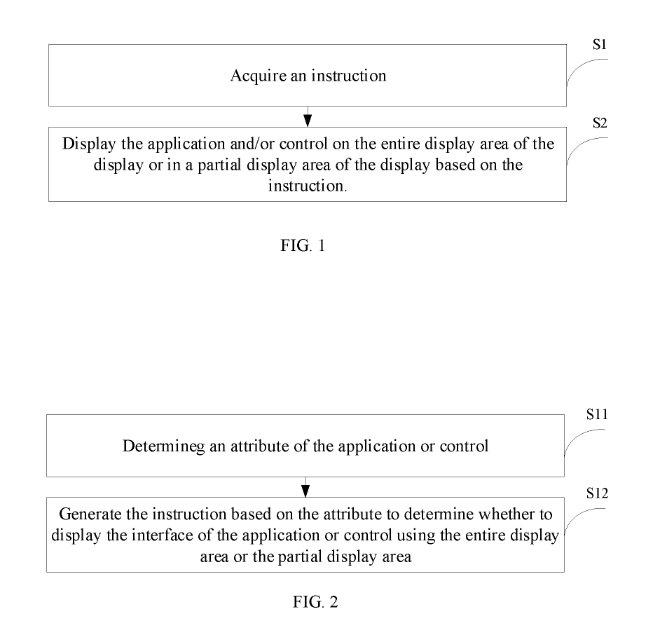

An embodiment of the present disclosure provides a display control method that may be used on electronic devices such as mobile phones or tablets. These electronic devices have displays to display contents, and these displays may be of different shapes, such as a regular rectangle or an irregular shape (e.g., a shape that is discontinuous, or a shape obtained by removing a part of a regular shape, i.e., the remaining portion of the regular shape). The display method provided in the present embodiment of the present disclosure allows contents that need to be displayed on the display of the electronic devices to be displayable on the regular or non-regular display. FIG. 1 shows a flowchart of a display control method consistent with the disclosure.

S1, acquiring an instruction. The instruction may be an instruction to control the display, or it may be a system default value, which may be a predetermined instruction automatically assigned by the system. After acquiring the instruction, the electronic device, such as a mobile phone, may execute the instruction so that the display may display contents corresponding to the instruction, for example, an application installed on the electronic device, such as a mobile phone, will display contents corresponding to the instruction for the user to view. In one embodiment, the instruction may be generated and acquired based on information related to the application and/or control, for example, a corresponding instruction may be generated and acquired for each application based on a predetermined set of rules.

S2, displaying the application and/or control on the entire display area of the display or in a partial display area of the display based on the instruction. In some embodiments, the entire display area of the display may include a non-regular display area. A non-regular display area may refer to a display area that is not a continuous display area of a regular shape (e.g., a rectangular shape). In one embodiment, the instruction may be generated based on the specific conditions of applications and/or controls installed on the electronic device to determine whether to display the applications and/or controls on the entire display area of the display. For example, when the entire display area is a regular rectangle, the application and/or control may display the complete contents in the entire rectangular display area based on the instruction; when the entire display area is a non-regular display area 1, the application and/or control may also display the complete contents in the entire non-regular display area based on the instruction. For example, the display of iPhone X manufactured by Apple is a non-regular display, and the application and/or control installed on iPhone X can display on the non-regular display.

In another embodiment, the instruction may be generated based on the specific conditions of the application and/or control installed on the electronic device to determine whether to display the application and/or control on a partial display area of the display. For example, when the entire display area is a regular rectangle, the application and/or control may display the contents on part of the entire rectangular display area (for example, displaying on half of the rectangular display area) based on the instruction; when the entire display area is the non-regular display area 1, to avoid incomplete display of the application and/or control (some applications and/or controls may be developed based on a regular display area, and may not be able to display properly in the non-regular display area 1), the application and/or control may be displayed in the partial area of the display, such as displaying in the regularly-shaped partial display area of the display of the non-regular display area 1 (it may be understood as displaying on the remaining portion of the display area after the irregular portion are cut off), so the entire contents may be completely displayed.

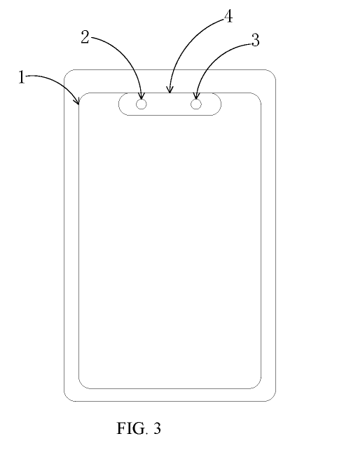

In one embodiment, in conjunction with FIG. 3, the entire display area of the display may be irregularly-shaped and a portion of the display area may be regularly-shaped, or the entire display area of the display may include discontinuous display areas and a portion of the display area may include a continuous display area. More specifically, in some electronic devices such as mobile phones, the entire display area of the display may be irregularly-shaped. For example, as shown in FIG. 3, the upper portion of the front side of the mobile phone includes an equipment area 4, in which a camera 2, and a sensor 3, etc., are arranged. The two sides of the equipment area 4 may be a specific display area, and the area other than the specific display area on the front side may also be a display area. If, other than the specific display area, the remaining display area is of a regular shape, and the application and/or control may be separately displayed in the regularly-shaped display area. In some electronic devices such as mobile phones, the entire display area of the display may include discontinuous display areas, such as a primary display and a secondary display that may be discontinuous; the partial display area of the display may be the primary display or the secondary display (the primary display and secondary display are portions of the entire display area), and the application and/or control may be separately displayed on the primary display or the secondary display.

FIG. 2 is a flowchart showing an example of acquiring the instruction consistent with the disclosure, as described in more detail below.

S11, determining an attribute of the application or control. The attribute of the application or control may include the application type, application dependency, etc. Further, the application type may include a gaming type, a video type, an image capturing type, a map type, etc., and the application dependency may include whether the application or control is a subroutine or a related application of an application whose attribute has been determined. After the attribute of the application or control is determined, the instruction may be generated based on the attribute.

S12, generating the instruction based on the attribute to determine whether to display the interface of the application or control using the entire display area or the partial display area. For example, when the application is a gaming application, video application, image capturing application, map application, etc., such application should be displayed on the entire display area, hence, the electronic device may set the default display behavior of the application to be displaying using the entire display area of the display. When the application is a utility application, such as a chatting application, sound processing application with menus and buttons, etc., the user may need to touch the displayed buttons to use the application. However, the application may not have been developed for electronic devices with a non-regular display area, therefore, this application may be displayed on the partial display area of the display, such as being displayed in the regularly-shaped display area formed by cutting off a portion of the non-regular display.

In one embodiment, the display control method may further include determining whether the interface of the application and/or control includes predetermined information in a specific area or whether it may be touch-controlled, and based on the outcome of the determination, determine whether to display the interface of the application and/or control using the entire display area or the partial display area. To more accurately determine the application and/or control, not only the attribute of the application and/or control may be processed, in the present embodiment, it is also possible to determine whether the interface of the application and/or control includes predetermined information in a specific area, or whether it may be touch-controlled.

In one embodiment, in conjunction with FIG. 3, the specific area may correspond to a non-displayable area of the electronic device with a non-regular display, such as the equipment area 4 with camera 2, in this case, if the specific area includes important information that can neither be normally displayed nor accept touch control, then the application and/or control may need to be displayed using the partial display area, such as displaying in the regularly-shaped display area formed by cutting off a portion of the non-regular display, so the user may use the application and/or control. In another embodiment, the interface of the application and/or control may not include important information in the specific area or it may not require touch control, even though the specific area may correspond to the non-displayable area of the electronic device with the non-regular display, the use of the application and/or control and the user experience will not be affected, so the application and/or control may be displayed using the entire display of the electronic device, that is, displayed on the entire display area of the display.

In one embodiment of the present disclosure, the display control method may further include determining whether to display the interface of the application and/or control using the entire display area or the partial display area based on multiple users' display settings of the application and/or control. More specifically, multiple users' display settings of the application and/or control may be recorded, so that when the interface of the same application and/or control need to be displayed, the corresponding record may be used to determine the corresponding display, that is, whether to display using the entire display area or the partial display area. In the present embodiment, regarding the user display setting of the application and/or control, if the majority of the users have been detected to use the entire display area to display a particular application and/or control, this data may be recorded, and when a user uses the same application and/or control again, the recorded data may be used to determine the display of the interface of the application and/or control, that is, the application and/or control may be displayed using the entire display area. Further, if the majority of the users have been detected to use the partial display area to display a particular application and/or control, this data may also be recorded, and when a user uses the same application and/or control again, the recorded data may be used to determine the display of the interface of the application and/or control, that is, the application and/or control may be displayed using the partial display area.

In one embodiment, the display control method may further include determining whether to display using the entire display area or the partial display area based on a detected touch control and/or hand gesture, or the area of the touch control; or, switching between displaying using the entire display area and displaying using the partial display area based on the detected touch control and/or the hand gestures, or the area of the touch control.

On one hand, the user may use touch controls and hand gestures to control electronic devices such as mobile phones, the control of different applications and/or controls may be different, and the two may have certain correspondence relationships. Further, the user may touch different areas of the display when performing the touch controls, the control of different applications and/or controls may be different, and the two may have certain correspondence relationships as well. These operations may be recorded so that when the same application and/or control is being used, and the same touch control and/or hand gesture is being applied, the corresponding display setting may be used based on the recorded information, that is, whether to display using the entire display area or the partial display area.

In one embodiment, regarding the detection of users' touch controls and hand gestures on an application and/or control, if the majority of the users have been detected to use the entire display area to display a particular application and/or control using the operations mentioned above, corresponding data may be recorded, and when a user uses the same application and/or control again with the same touch control and/or hand gesture the application and/or control can be displayed using the entire display area according to the recorded data. Further, if the majority of the users have been detected to use the partial display area to display a particular application and/or control using touch control and/or hand gesture, corresponding data may also be recorded, and when a user uses the same application and/or control again with the same touch control and/or hand gesture, the application and/or control can be displayed using the partial display area according to the recorded data. In addition, the method of processing touching different areas of the display is similar to the method of processing touch controls and/or hand gestures and will not be repeated herein.

On the other hand, in conjunction with the above embodiments, the electronic device may switch the display mode of the application and/or control, for example, an application and/or control may correspond to electronic devices of different types or models. The display setting data collected may not be complete or available (without the corresponding usage record), especially for new electronic devices or electronic devices with new designs, therefore, the electronic device may display the application and/or control based on the available data (such as displaying on the entire display area or the partial display area), and the display setting may not be optimal or the preferred display setting. At this point, based on the touch control and/or hand gesture, or the area of the touch control, the electronic device may switch the default display setting of the application and/or control to better fit the user's needs.

An embodiment of the present disclosure further provides an electronic device. The electronic device may be a mobile phone, tablet, etc., and the electronic device may include a displayable display and it may be of different shapes, such as a regular rectangle or an irregular shape (e.g., a shape that is discontinuous, or a shape obtained by removing a part of a regular shape, i.e., the remaining portion of the regular shape). The contents that need to be displayed on the display of the electronic device may be displayed on the regular or non-regular display. The electronic may further include a storage device and a processor, where the storage device may be used to store applications and/or controls, and computer executable instructions, the display may be used to display the application and/or control, and the processor may be used to execute the computer program instructions to:

Acquire an instruction. The instruction may be an instruction to control the display, or it may be a system default value, which may be a predetermined instruction automatically assigned by the system. After acquiring the instruction, the electronic device, such as a mobile phone, may execute the instruction so that the display may display contents corresponding to the instruction, for example, an application installed on the electronic device, such as a mobile phone, will display contents corresponding to the instruction for the user to view. In one embodiment, the instruction may be generated and acquired based on information related to the application and/or control, for example, a corresponding instruction may be generated and acquired for each application based on a predetermined set of rules.

Display the application and/or control on the entire display area of the display or in a partial display area of the display based on the instruction. In some embodiments, the entire display area of the display may include a non-regular display area. In one embodiment, the instruction may be generated based on the specific conditions of applications and/or controls installed on the electronic device to determine whether to display the application and/or control on the entire display area of the display. For example, when the entire display area is a regular rectangle, the application and/or control may display the complete contents in the entire rectangular display area based on the instruction; when the entire display area is a non-regular display area, the application and/or control may also display the complete contents in the entire non-regular display area based on the instruction. For example, the display of iPhone X manufactured by Apple is a non-regular display, and the application and/or control installed on an iPhone X can display on the non-regular display.

In another embodiment, the instruction may be generated based on the specific conditions of the application and/or control installed on the electronic device to determine whether to display the application and/or control on a partial display area of the display. For example, when the entire display area is a regular rectangle, the application and/or control may display the contents on part of the entire rectangular display area (for example, displaying on half of the rectangular display area) based on the instruction; when the entire display area is the non-regular display area, to avoid incomplete display of the application and/or control (some applications and/or controls may be developed based on a regular display area, and may not be able to display properly in the non-regular display area), the application and/or control may be displayed in the partial area of the display, such as displaying in the regularly-shaped partial display area of the display of the non-regular display area (it may be understood as displaying on the remaining portion of the display area after the irregular portion are cut off), so the entire contents may be completely displayed.

In one embodiment, in conjunction with FIG. 3, the entire display area of the display of the electronic device may be irregularly-shaped and a portion of the display area may be regularly-shaped, or the entire display area of the display may include discontinuous display areas and a portion of the display area may include a continuously display area. More specifically, in some electronic devices such as mobile phones, the entire display area of the display may be irregularly-shaped. For example, as shown in FIG. 3, the upper portion of the front side of the mobile phone includes the equipment area 4, in which a camera 2, and a sensor 3, etc. are arranged. The two sides of the equipment area 4 may be a specific display area, and the area other than the specific display area on the front side may also be a display area. If, other than the specific display area, the remaining display area is of a regular shape, and applications and/or controls may be separately displayed in the regularly-shaped display area. In some electronic devices such as mobile phones, the entire display area of the display may include discontinuous display areas, such as a primary display and a secondary display that may be discontinuous; the partial area of the display area may be the primary display or the secondary display (the primary display and secondary display are portions of the entire display area), applications and/or controls may be separately displayed on the primary display or the secondary display.

In one embodiment of the present disclosure, in conjunction with FIG. 3, the electronic device may further include a sensor 3 and an image capturing device. The non-regular display area 1 may be a display area located on at least one side of the sensor 3, or a display area location on at least one side of the image capturing device. For example, when the electronic device is a mobile phone, the sensor 3 may be an object sensor installed at the upper portion of the front side of the mobile phone (to sense the distance of the human body, etc.), and the image capturing device may also be installed at the upper portion of the front side of the mobile phone such as camera 2 for capturing images. Similar to Apple's iPhone X, the non-regular display area 1 may include a display area located on at least one side of the sensor 3, and it may also include a display area located on both the left and right sides of the sensor 3. In some embodiments, the non-regular display area 1 may include a display area located on at least one side of the image capturing device, and it may also include a display area located on both the left and right sides of the image capturing device. Of course, the electronic device may be another mobile phone with a unique display design, the non-regular display area 1 may further include other display areas, and details are not described herein again.

In one embodiment of the present disclosure, the processor may further execute the computer program instructions to:

Determine an attribute of the applications or controls. The attribute of the application and/or control may include the application type, application dependency, etc. Further, the application type may include a gaming type, a video type, an image capturing type, a map type, etc., and the application dependency may include whether the application and/or control is a subroutine or a related application of an application whose attribute has been determined. After the attribute of the application and/or control is determined, the instruction may be generated based on the attribute.

Generate an instruction based on the attribute to determine whether to display the interface of the application and/or control using the entire display area or the partial display area. For example, when the application is a gaming application, video application, capturing application, map application, etc., such application should be displayed on the entire display area, hence, the electronic device may set the default display behavior of the application to be displaying using the entire display area of the display. When the application is a utility application, such as a chatting application, sound processing application with menus and buttons, etc., the user may need to touch the displayed buttons to use the application. However, the application may not have been developed for electronic devices with non-regular display area, therefore, this application may be displayed on the partial display area of the display, such as being displayed in the regularly-shaped display area formed by cutting off a portion of the non-regular display.

In one embodiment of the present disclosure, the processor may further execute the computer program instructions to:

Determine whether the interface of the application and/or control includes predetermined information in a specific area or whether it may be touch-controlled, and based on the outcome of the determination, determine whether to display the interface of the application and/or control using the entire display area or the partial display area. To more accurately determine the application and/or control, not only the attribute of the application and/or control may be processed, in the present embodiment, it is also possible to determine whether the interface of the application and/or control includes predetermined information in a specific area, or whether it may be touch-controlled.

In one embodiment, in conjunction with FIG. 3, the specific area may correspond to a non-displayable area of the electronic device with a non-regular display, such as the equipment area 4 with camera 2, in this case, if the specific area includes important information that can neither be normally displayed nor accept touch control, then the application and/or control may need to be displayed using the partial display area, such as displaying in the regularly-shaped display area formed by cutting off a portion of the non-regular display, so the user may use the application and/or control. In another embodiment, the interface of the application and/or control may not include important information in the specific area or it may not require touch control, even though the specific area may correspond to the non-displayable area of the electronic device with the non-regular display, the use of the application and/or control and the user experience will not be affected, so the application and/or control may be displayed using the entire display of the electronic device, that is, displayed on the entire display area of the display.

In one embodiment of the present disclosure, the processor may further execute the computer program instructions to:

Determine whether to display the interface of the application and/or control using the entire display area or the partial display area based on multiple users' display settings of the application and/or control. More specifically, multiple users' display settings of the application and/or control may be recorded, so that when the interface of the same applications and/or controls need to be displayed, the corresponding record may be used to make the corresponding display, that is, whether to display using the entire display area or the partial display area. In the present embodiment, regarding the user display setting of the application and/or control, if the majority of the users have been detected to use the entire display area to display a particular application and/or control, this data may be recorded, and when a user uses the same application and/or control again, the recorded data may be used to determine the display of the interface of the application and/or control, that is, the application and/or control may be displayed using the entire display area. Further, if the majority of the users have been detected to use the partial display area to display a particular application and/or control, this data may also be recorded, and when a user uses the same application and/or control again, the recorded data may be used to determine the display of the interface of the application and/or control, that is, the application and/or control may be displayed using the partial display area.

Those skilled in the art may clearly understand that, for ease and concision of the descriptions, the aforementioned processing method may be applied to the related electronic devices, and the related details may refer to corresponding descriptions in the disclosed embodiments, which are not repeated herein.

The embodiments in this specification are described in a progressive manner, each embodiment emphasizes a difference from the other embodiments, and the identical or similar parts between the embodiments may be made reference to each other. Since the apparatuses disclosed in the embodiments are corresponding to the methods disclosed in the embodiments, the description of the apparatuses is simple and relevant parts may be made reference to the description of the methods.

Persons skilled in the art may further realize that, units and steps of algorithms according to the description of the embodiments disclosed by the present disclosure can be implemented by electronic hardware, computer software, or a combination of the two. In order to describe interchangeability of hardware and software clearly, compositions and steps of the embodiments are generally described according to functions in the forgoing description. Whether these functions are executed by hardware or software depends upon specific applications and design constraints of the technical solutions. Persons skilled in the art may use different methods for each specific application to implement the described functions, and such implementation should not be construed as a departure from the scope of the present disclosure.

The methods or algorithms described in the embodiments of the present disclosure may be implemented by hardware, software modules executed by the processor, or a combination of both. The software module can be placed in a random access memory (RAM), memory, read only memory (ROM), electrically programmable ROM, electrically erasable and programmable ROM, register, hard disk, mobile disk, CD-ROM, or any other form of storage medium known to the technical domain.

It will be understood by those skilled in the art that the features described in the respective embodiments and/or claims of the present disclosure can be combined in various ways, even if such combinations are not explicitly described in the present disclosure. In particular, without departing from the spirit and teaching of the present disclosure, the features described in the respective embodiments and/or claims can be combined in various ways. All of these combinations fall within the scope of the present disclosure.

While the present disclosure has been shown and described with reference to various embodiments thereof, it will be understood by those skilled in the art that various modifications in form and details may be made without departing from the spirit and scope of the present disclosure as defined by the appended claims and their equivalents. Therefore, the scope of the present disclosure should not be limited to the above-described embodiments.

It should be noted that the description of the foregoing embodiments of the electronic device may be similar to that of the foregoing method embodiments, and the device embodiments have the same beneficial effects as those of the method embodiments. Therefore, details may not be described herein again. For technical details not disclosed in the embodiments of the electronic device of the present disclosure, those skilled in the art may understand according to the method embodiments of the present disclosure.

In the several embodiments provided in the present disclosure, it should be understood that the disclosed device and method may be realized in other manners. The device embodiments described above are merely examples. All functional modules or units in the embodiments of the present disclosure may all be integrated in one processing unit, or each unit may be used as a single unit. Two or more units may be integrated in one. The above integrated unit can either be implemented in the form of hardware, or in the form of hardware combined with software functional units.

Persons of ordinary skill in the art should understand that, all or a part of steps of implementing the foregoing method embodiments may be implemented by related hardware of an computer instruction program. The instruction program may be stored in a computer-readable storage medium, and when executed, a processor executes the steps of the above method embodiments as stated above. The foregoing storage medium may include various types of storage media, such as a removable storage device, a read only memory (ROM), a random-access memory (RAM), a magnetic disk, or any media that stores program code.

Alternatively, when the above-mentioned integrated units of the present disclosure are implemented in the form of a software functional module being sold or used as an independent product, the integrated unit may also be stored in a computer-readable storage medium. Based on this understanding, the technical solutions provided by the embodiments of the present disclosure essentially or partially may be embodied in the form of a software product stored in a storage medium. The storage medium stores instructions which are executed by a computer device (which may be a personal computer, a server, a network device, or the like) to realize all or a part of the embodiments of the present disclosure. The above-mentioned storage medium may include various media capable of storing program codes, such as a removable storage device, a read only memory (ROM), a random-access memory (RAM), a magnetic disk, or an optical disk.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

The foregoing descriptions only illustrate some embodiments of the present disclosure, and the protection scope of the present disclosure is not limited thereto. The scope that anyone skilled in the art may easily conceive changes and substitutions within the technical scope disclosed in the present disclosure that should be covered by the present disclosure. Therefore, the protection scope of the present disclosure should be subject to the scope of the claims as listed in the following.

What is claimed is:

1. A display control method comprising:
acquiring an instruction; and
displaying at least one of an application or a control on an entire display area of a display or a partial display area of the display based on the instruction, the entire display area of the display including a non-regular display area.

2. The method according to claim 1, wherein:
the entire display area of the display is irregularly-shaped and the partial display area of the display is regularly-shaped; or
the entire display area of the display includes a discontinuous area and the partial display area includes a continuous area.

3. The method according to claim 1, wherein acquiring the instruction includes:
determining an attribute of the at least one of the application or the control; and
generating the instruction based on the attribute to determine whether to display an interface of the at least one of the application control using the entire display area or the partial display area.

4. The method according to claim 1, further comprising:
determining whether an interface of the at least one of the application or the control includes predetermined information in a specific area or whether the interface is touch-controllable; and
based on the determination, determining whether to display the interface of the at least one of the application or the control using the entire display area or the partial display area.

5. The method according to claim 4, wherein the specific area corresponds to a non-displayable area.

6. The method according to claim 1, further comprising:
determining whether to display an interface of the at least one of the application or the control using the entire display area or the partial display area based on multiple display settings of the at least one of the application or the control.

7. The method according to claim 1, further comprising:
determining whether to display using the entire display area or the partial display area based on a detected touch control and/or hand gesture, or an area of the touch control; or
switching between displaying using the entire display area and displaying using the partial display area based on the detected touch control and/or hand gesture, or the area of the touch control.

8. An electronic device comprising:
a storage device storing at least one of an application or a control, and a computer program;
a display configured to display the at least one of the application or the control; and
a processor configured to execute the computer program to:
acquire an instruction; and
display the at least one of the application or the control on an entire display area of the display or a partial display area of the display based on the instruction, the entire display area of the display including a non-regular display area.

9. The electronic device according to claim 8, wherein:
the entire display area of the display is irregularly-shaped and the partial display area of the display is regularly-shaped; or
the entire display area of the display includes a discontinuous area and the partial display area includes a continuous area.

10. The electronic device according to claim 8, further comprising:
a sensor; and
an image capturing device;
wherein the non-regular display area includes a display area located on at least one side of the sensor, or a display area located on at least one side of the image capturing device.

11. The electronic device according to claim 8, wherein the processor further executes the computer program to:
determine an attribute of the at least one of the application or the control; and
generate the instruction based on the attribute to determine whether to display an interface of the at least one of the application or the control using the entire display area or the partial display area.

12. The electronic device according to claim 8, wherein the processor further executes the computer program to:
determine whether an interface of the at least one of the application or the control includes predetermined information in a specific area or whether it is touch-controllable; and
based on the determination, determine whether to display the interface of the at least one of the application or the control using the entire display area or the partial display area.

13. The electronic device according to claim 12, wherein the specific area corresponds to a non-displayable area.

14. The electronic device according to claim 8, wherein the processor further executes the computer program to:
determine whether to display an interface of the at least one of the application or the control using the entire display area or the partial display area based on multiple display settings of the at least one of the application or the control.

15. The electronic device according to claim 8, the processor further executes the computer program to:
determine whether to display using the entire display area or the partial display area based on a detected touch control and/or hand gesture, or an area of the touch control; or
switch between displaying using the entire display area and displaying using the partial display area based on the detected touch control and/or hand gesture, or the area of the touch control.
